(19) United States
(12) Patent Application Publication
(10) Pub. No.: US 2009/0284967 A1
(43) Pub. Date: Nov. 19, 2009

(54) LIGHTING APPARATUS AND IMAGE READING APPARATUS

(75) Inventor: Hiroyuki MARUYAMA, Ishikawa (JP)

Correspondence Address: LOWE HAUPTMAN HAM & BERNER, LLP, 1700 DIAGONAL ROAD, SUITE 300, ALEXANDRIA, VA, 22314, US

(73) Assignee: PFU LIMITED, ISHIKAWA (JP)

(21) Appl. No.: 12/258,995

(22) Filed: Oct. 27, 2008

(30) Foreign Application Priority Data
May 15, 2008 (JP) 2008-128672

(51) Int. Cl. F21V 33/00; F21V 7/00

(52) U.S. Cl. 362/234; 362/235

(57) ABSTRACT

A lighting apparatus lights up a lighting target and includes a first substrate with a first LED group mounted thereon, and a second substrate with a second LED group mounted thereon. First LEDs of the first LED group and second LEDs of the second LED group are equally spaced in line and face with each other. Light beams emitted from the first LEDs and the second LEDs are reflected by reflection surfaces of the first and the second substrate as they travel toward the lighting target and gather in a space between a first protruding portion of the first substrate and a second protruding portion of the second substrate, and applied to the lighting target.

### BACKGROUND OF THE INVENTION

1. Field of the Invention

The present invention relates to a lighting apparatus for use as, for example, a backlight of a liquid-crystal display apparatus or a light source of an image reading apparatus, and to an image reading apparatus with the lighting apparatus.

2. Description of the Related Art Japanese Patent Application Laid-open Publication No. 2005-174820 discloses an example of a lighting apparatus that applies light toward a lighting target by simultaneously lighting up a plurality of light-emitting diodes (LEDs) to linearly light up the lighting target.

In the lighting apparatus disclosed in the above document, the LEDs are mounted on a single substrate so as to be equally spaced apart from each other in line, with their light emitting directions aligned. When these LEDs are simultaneously lit up, light beams from these LEDs are applied to the lighting target. As a result, the lighting target is linearly lit up by the LEDs. The lighting apparatus of this type is used as, for example, a backlight of a liquid-crystal display apparatus or a light source of an image reading apparatus.

To downsize the apparatus to which the lighting apparatus of the type explained above is applied, for example, the lighting apparatus is disposed near the lighting target. With this, the distance between the LEDs and the lighting target is shortened, resulting in insufficient diffusion of light applied to the lighting target. Thus, in the light applied to the lighting target, in other words, the light that linearly lights up the lighting target, ripples occur, representing unevenness in illuminance. To suppress such ripples, when there is a space between adjacent LEDs, an arrangement pitch of the LEDs arranged in line can be narrowed, but cannot be narrowed any more if these adjacent LEDs interfere with each other. For this reason, there is still a need for suppressing ripples.

### SUMMARY OF THE INVENTION

It is an object of the present invention to at least partially solve the problems in the conventional technology.

According to one aspect of the present invention, a lighting apparatus that lights up a lighting target includes a first substrate having a first mounting surface, a first LED group formed of a plurality of first LEDs of side-view type each mounted on the first mounting surface to emit a first light beam from a side surface facing the lighting target toward the lighting target, the first LEDs being arranged so as to be equally spaced in line in an arranging direction, a second substrate having a second mounting surface facing the first mounting surface, and a second LED group formed of a plurality of second LEDs of side-view type each mounted on the second mounting surface to emit a second light beam from a side surface facing the lighting target toward the lighting target. The second LEDs is arranged so as to be equally spaced in line in the arranging direction, and the second LED group is arranged at a position facing the first LED group. A first arrangement pitch representing a pitch between the first LEDs of the first LED group is shifted in phase in the arranging direction from a second arrangement pitch representing a pitch between the second LEDs of the second LED group. The first substrate has a first protruding portion that protrudes from a lighting-target side of the mounted first LED group toward the lighting target, and the second substrate has a second protruding portion that protrudes from a lighting-target side of the mounted second LED group toward the lighting target, and a reflection surface that reflects the first light beams and the second light beams is formed at a first-mounting-surface side of the first protruding portion, and at a second-mounting-surface side of the second protruding portion. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic side view of a lighting apparatus according to a first embodiment;

FIG. 2 is a schematic perspective view of the lighting apparatus;

FIG. 3 is a perspective view of the lighting apparatus when applied to an image reading apparatus;

FIGS. 4A and 4B are drawings of a relation between diffusion of a first light beam and a second light beam in the lighting apparatus and a luminance distribution of the first light beams and the second light beams emitted from the first LEDs and the second LEDs;

FIG. 5 is a schematic diagram for explaining the illuminance of light emitted from a lighting apparatus according to a second embodiment;

FIG. 6 is a graph of measurement results of ripples in linear light applied from the lighting apparatus of the second embodiment to a lighting target;

FIG. 7 is a graph of measurement results of ripples in the linear light applied from the lighting apparatus to the lighting target when variations in luminance occur among the LEDs;

FIG. 8 is a schematic diagram of a lighting apparatus according to a third embodiment;

FIG. 9 is a graph of measurement results of ripples in linear light applied from the lighting apparatus of the third embodiment to a lighting target;

FIG. 10 is a graph of measurement results of ripples in the linear light applied from the lighting apparatus to the lighting target when variations in luminance occur among the LEDs;

FIG. 11 is a schematic side view of a lighting apparatus according to a fourth embodiment;

FIG. 12 is a perspective view of a characteristic portion of a lighting apparatus according to a fifth embodiment;

FIG. 13 is a cross-sectional view of a characteristic portion of the lighting apparatus depicted in FIG. 12;

FIG. 14A is a front view of a characteristic portion of a lighting apparatus according to a sixth embodiment;

FIG. 14B is a side view of the characteristic portion of the lighting apparatus of FIG. 14B;

FIG. 15A is a front view of a characteristic portion of another example of the lighting apparatus according to the sixth embodiment;

FIG. 15B is a side view of the characteristic portion of the lighting apparatus of FIG. 15A; and

FIG. 16 is a side view of a lighting apparatus according to a seventh embodiment when applied to an image reading apparatus.

### DETAILED DESCRIPTION OF THE PREFERRED EMBODIMENTS

Embodiments of the lighting apparatus according to the present invention are explained in detail below based on the drawings. Note that the present invention is not meant to be limited by each of these embodiments below.

### First Embodiment

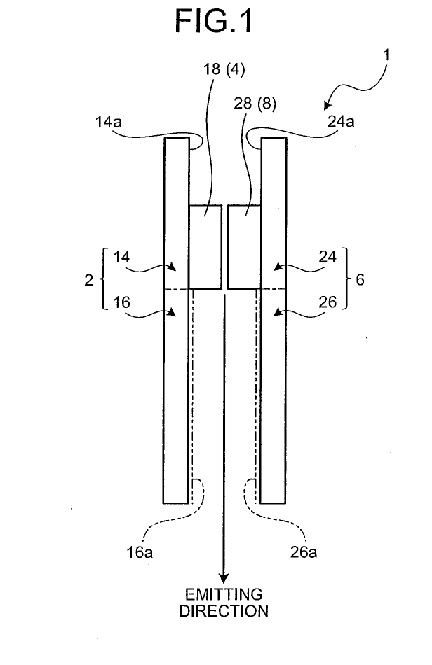

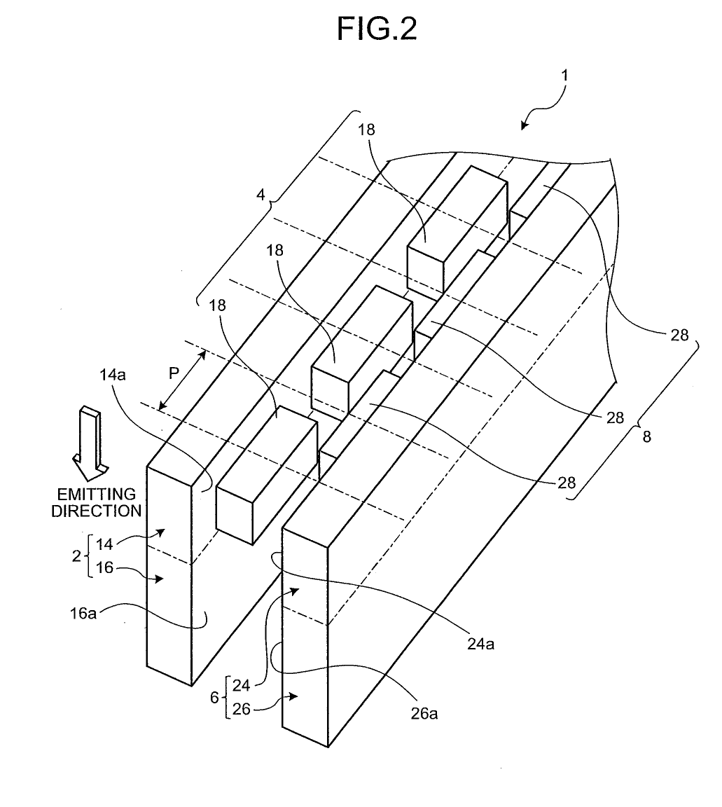

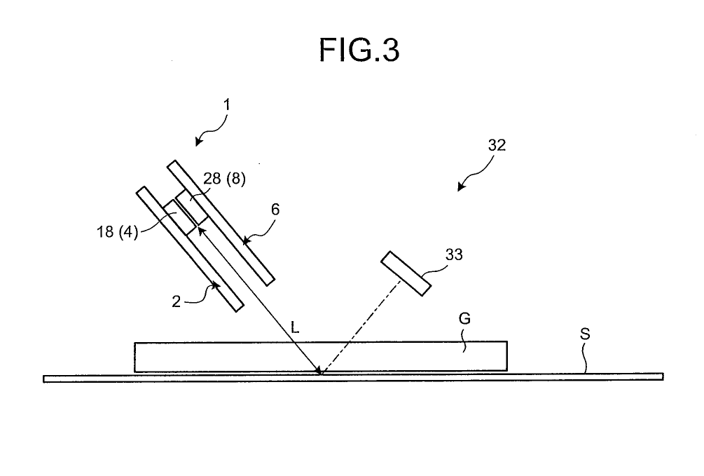

A lighting apparatus according to a first embodiment is explained below. FIG. 1 is a schematic side view of the lighting apparatus according to the first embodiment. FIG. 2 is a schematic perspective view of the lighting apparatus. FIG. 3 is a side view of the lighting apparatus when applied to an image reading apparatus.

A lighting apparatus 1 lights up a lighting target. The lighting apparatus 1 includes a first substrate 2, a first light-emitting-diode (LED) group 4, a second substrate 6, and a second LED group 8. In the first embodiment, an example is explained in which the lighting apparatus 1 is used as a light source of an image reading apparatus.

The first substrate 2 is to mount the first LED group 4. The first substrate 2 is formed in a rectangular-plate shape, for example. The first substrate 2 is a printed board, for example. The first substrate 2 includes a substrate body 14 and a first protruding portion 16. The first substrate 2 is sectioned as the substrate body 14 and the first protruding portion 16 so that when the first substrate 2 is disposed with respect to an image reading medium S as a lighting target, which will be explained further below, the first protruding portion 16 is positioned on an image reading medium S side and the substrate body 14 is positioned opposite to the image reading medium S the first protruding portion 16 placed between the image reading medium S and the substrate body 14.

The substrate body 14 has a first mounting surface 14a, which is one surface of the substrate body 14 in a plate-thickness direction. The first mounting surface 14a has mounted thereon the first LED group 4, which will be explained further below. In the first embodiment, the first mounting surface 14a is a white resist. The first mounting surface 14a in the first embodiment is formed by, for example, coating the substrate body 14 with a white resist.

On the other hand, the first mounting surface 14a side of the first protruding portion 16, which is one side thereof in a plate-thickness direction, has formed thereon a reflection surface 16a. The reflection surface 16a is integrally formed with the first mounting surface 14a. The reflection surface 16a is a mirror surface or white diffusion reflection surface. In the first embodiment, the reflection surface 16a is a white resist. That is, in the first embodiment, the reflection surface 16a and the first mounting surface 14a are white resists. The reflection surface 16a in the first embodiment is formed by, for example, coating a surface of the first protruding portion 16 on one side in a plate-thickness direction with a white resist.

The first LED group 4 is configured of a plurality of, for example, five in the first embodiment, first LEDs 18. Each of the first LEDs 18 is to apply a first light beam to the image reading medium S as a lighting target, which will be explained further below. The first LEDs 18 of the first LED group 4 are mounted on the first mounting surface 14a of the substrate body 14 of the first substrate 2. Each of the first LEDs 18 is a side-view LED that emits light in a direction approximately orthogonal to the plate-thickness direction of the substrate body 14. Each of the first LEDs 18 is mounted on the first mounting surface 14a of the substrate body 14 so that its light-emitting surface is on the first protruding portion 16 side. Furthermore, the first LEDs 18 forming the first LED group 4 are mounted on the first mounting surface 14a so as to be equally spaced apart, with a space (2×P) in the first embodiment, in line in a direction parallel to an end of the first protruding portion 16 on an image reading medium S side. Here, the light-emitting surfaces of all first LEDs 18 and the end of the reflection surface 16a of the first protruding portion 16 on the image reading medium S side are parallel to each other. In this manner, the first LEDs 18 are arranged so as to be equally spaced apart, with a space (2×P) in the first embodiment, in an arranging direction parallel to the end of the first protruding portion 16, thereby forming the first LED group 4. The first LEDs 18 forming the first LED group 4 in the manner as explained above are simultaneously lit up by a lighting controlling unit not shown.

The second substrate 6 is to mount the second LED group 8. The second substrate 6 is formed in a rectangular-plate shape, for example. In the first embodiment, the second substrate 6 is the same shape as that of the first substrate 2 explained above. The second substrate 6 is a printed board, for example. The second substrate 6 includes a substrate body 24 and a second protruding portion 26. The second substrate 6 is sectioned as the substrate body 24 and the second protruding portion 26 so that when the second substrate 6 is disposed with respect to the image reading medium S as a lighting target, which will be explained further below, the second protruding portion 26 is positioned on an image reading medium S side and the substrate body 24 is positioned opposite to the image reading medium S with the second protruding portion 26 placed between the image reading medium S and the second protruding portion 26.

The substrate body 24 has a second mounting surface 24a, which is one surface of the substrate body 24 in a plate-thickness direction. The second mounting surface 24a has mounted thereon the second LED group 8, which will be explained further below. In the first embodiment, the second mounting surface 24a is a white resist. The second mounting surface 24a in the first embodiment is formed by, for example, coating the substrate body 24 with a white resist.

On the other hand, the second mounting surface 24a side of the second protruding portion 26, which is one side thereof in a plate-thickness direction, has formed thereon a reflection surface 26a. The reflection surface 26a is integrally formed with the second mounting surface 24a. The reflection surface 26a is a mirror surface or white diffusion reflection surface. In the first embodiment, the reflection surface 26a is a white resist. That is, in the first embodiment, the reflection surface 26a and the second mounting surface 24a explained above are white resists. The reflection surface 26a in the first embodiment is formed by, for example, coating a surface of the second protruding portion 26 on one side in a plate-thickness direction with a white resist.

The second LED group 8 is configured of a plurality of, for example, five in the first embodiment, second LEDs 28. Each of the second LEDs 28 is to apply a second light beam to the image reading medium S as a lighting target, which will be explained further below. The second LEDs 28 of the second LED group 8 are mounted on the second mounting surface 24a of the substrate body 24 of the second substrate 6. Each of the second LEDs 28 is a side-view LED that emits light in a direction approximately orthogonal to the plate-thickness direction of the substrate body 24. Each of the second LEDs 28 is mounted on the second mounting surface 24a of the substrate body 24 so that its light-emitting surface is on the second protruding portion 26 side. Furthermore, the second LEDs 28 forming the second LED group 8 are mounted on the second mounting surface 24a so as to be equally spaced apart, with a space (2×P) in the first embodiment, in line in a direction parallel to an end of the second protruding portion 26 on an image reading medium S side. Here, the light-emitting surfaces of all second LEDs 28 and the end of the reflection surface 26a of the second protruding portion 26 on the image reading medium S side are parallel to each other. In this manner, the second LEDs 28 are arranged so as to be equally spaced apart, with a space (2×P) in the first embodiment, in an arranging direction parallel to the end of the second protruding portion 26, thereby forming the second LED group 8. All of the second LEDs 28 forming the second LED group 8 in the manner as explained above are simultaneously lit up by the lighting controlling unit not shown, together with the first LEDs 18 of the first LED group 4. In other words, each of the first LEDs 18 of the first LED group 4 and each of the second LEDs 28 of the second LED group 8 are all simultaneously lit up by the lighting controlling unit not shown.

The second substrate 6 is disposed so as to face the first substrate 2. In more detail, the second substrate 6 is disposed so as to face the first substrate 2 in a manner such that the first mounting surface 14a of the substrate body 14 of the first substrate 2 and the second mounting surface 24a of the substrate body 24 of the second substrate 6 face each other and the reflection surface 16a of the first protruding portion 16 of the first substrate 2 and the reflection surface 26a of the second protruding portion 26 of the second substrate 6 face each other. As a result, the light-emitting surfaces of the first LEDs 18 and the light-emitting surfaces of the second LEDs 28 are flush with each other. In this manner, the second substrate 6 is disposed so as to face the first substrate 2 and be spaced apart therefrom in parallel in a manner such that the first LED group 4 formed of the first LEDs 18 mounted on the first substrate 2 and the second LED group 8 formed of the second LEDs 28 mounted on the second substrate 6 face each other. Here, a first arrangement pitch (in the first embodiment, a space (2×P)) representing a pitch between the first LEDs 18 of the first LED group 4 mounted on the first substrate 2 and a second arrangement pitch (in the first embodiment, a space (2×P)) representing a pitch between the second LEDs 28 of the second LED group 8 mounted on the second substrate 6 are shifted in phase by, for example, ½, in an arranging direction of the first and second LEDs 18 and 28. In the first embodiment, the second substrate 6 is disposed so that the first and second substrates 2 and 6 overlap each other when the first substrate 2 is moved in parallel in a plate-thickness direction. The position where each first LED 18 is to be mounted onto the first substrate 2 and the position where each second LED 28 is to be mounted onto the second substrate 6 are predetermined so that the first arrangement pitch of the first LED group 4 and the second arrangement pitch of the second LED group 8 are shifted in phase by ½ when the first substrate 2 and the second substrate 6 are disposed to face each other. Alternatively, the second substrate 6 may be moved in parallel along an arrangement direction of the second LEDs 28 with respect to the first substrate 2, for example, so that the first arrangement pitch of the first LED group 4 and the second arrangement pitch of the second LED group 8 are shifted in phase by ½ when the first substrate 2 and the second substrate 6 are disposed to face each other, even when the first substrate 2 and the second substrate 6 do not overlap each other when the first substrate 2 is moved in parallel in a plate-thickness direction. Here, the first substrate 2 and the second substrate 6 with the first arrangement pitch of the first LED group 4 and the second arrangement pitch of the second LED group 8 being shifted in phase by ½ are connected together via, for example, a fixing unit not shown.

As depicted in FIG. 3, the lighting apparatus 1 is used as, for example, a light source of an image reading apparatus 32. The lighting apparatus 1 is disposed so that the light-emitting surfaces of the first LEDs 18 and the second LEDs 28 face an imaging position where the sheet-like image reading medium S, such as a document, as a lighting target is imaged. As a result, along a direction of emitting the first light beams and the second light beams, the first protruding portion 16 of the lighting apparatus 1 protrudes toward an image reading medium S side of the first LED group 4 mounted on the first mounting surface 14a, that is, from a light-emitting surface side of each of the first LEDs 18 of the first LED group 4 of the substrate body 14 toward the image reading medium S, so as to be near the image reading medium S. Also, along the direction of emitting the first light beams and the second light beams, the second protruding portion 26 of the lighting apparatus 1 protrudes toward an image reading medium S side of the second LED group 8 mounted on the second mounting surface 24a, that is, from a light-emitting surface side of each of the second LEDs 28 of the second LED group 8 of the substrate body 24 toward the image reading medium S, so as to be near the image reading medium S. That is, two ends of the first substrate 2 and the second substrate 6 in pair on the image reading medium S side both protrude near the image reading medium S. In the lighting apparatus 1 as explained above, each of the first LEDs 18 of the first LED group 4 emits a first light beam from its light-emitting surface, which is a side surface facing the image reading medium S, toward the image reading medium S, whilst each of the second LEDs 28 of the second LED group 8 emits a second light beam from its light-emitting surface, which is a side surface facing the image reading medium S, toward the image reading medium S. Each of the first LEDs 18 of the first LED group 4 and each of the second LEDs 28 of the second LED group 8 are simultaneously lit up by a lighting controlling unit not shown, thereby emitting light toward the image reading medium S as a lighting target. Here, in the image reading apparatus 32, the arranging direction of the first LEDs 18 and the arranging direction of the second LEDs 28 represent a main scanning direction. In the first embodiment, the lighting apparatus 1 is disposed so as to be tilted by a predetermined angle with respect to the direction of the normal to the image reading medium S at an imaging position.

In the image reading apparatus 32, an imaging unit 33 included in the image reading apparatus 32 images the image reading medium S, which is a lighting target lit up by the lighting apparatus 1.

The imaging unit 33 is configured of, for example, a plurality of CCD (Charge Coupled Device) imaging elements. Alternatively, the imaging unit 33 may be configured of, for example, a plurality of CMOS (Complementary Metal Oxide Semiconductor) imaging elements. The imaging elements configuring the imaging unit 33 are arranged in line in the main scanning direction (the direction in which the first LEDs 18 and the second LEDs 28 are arranged). For example, with the image reading medium S being conveyed by a conveying unit not shown in a sub-scanning direction, the imaging unit 33 scans the entire area of the image reading medium S. Thus, when the image reading medium S is conveyed by the conveying unit not shown in the sub-scanning direction, light from the lighting apparatus 1 reflected from the image reading medium S, that is, reflected light, enters each imaging element of the imaging unit 33. Therefore, from each imaging element of the imaging unit 33, an image signal obtained through imaging is output for each exposure for the entire area of the image reading medium S. Here, the image signal obtained through imaging is transmitted to, for example, an image-data generating apparatus connected to the image reading apparatus 32. In the image-data generating apparatus, the image signal obtained through imaging and transmitted from the imaging unit 33 is subjected to predetermined image processing to generate image data obtained through imaging for the entire area of the image reading medium S. In this manner, for example, the imaging unit 33 images the image reading medium S based on linear light from the lighting apparatus 1 reflected from the image reading medium S conveyed by the conveying unit not shown in the sub-scanning direction.

Here, a member denoted by a reference character “G” in FIG. 3 is a transparent image-reading plate member having, for example, a rectangular plate shape. The image-reading plate member G presses the image reading medium S onto a side of a medium supporting member not shown and provided so as to be opposite to the image-reading plate member G with respect to a conveying path, which is a locus of movement of the image reading medium S, thereby suppressing lifting of the image reading medium S from the medium supporting member.

Next, the operation of the lighting apparatus 1 according to the first embodiment is explained.

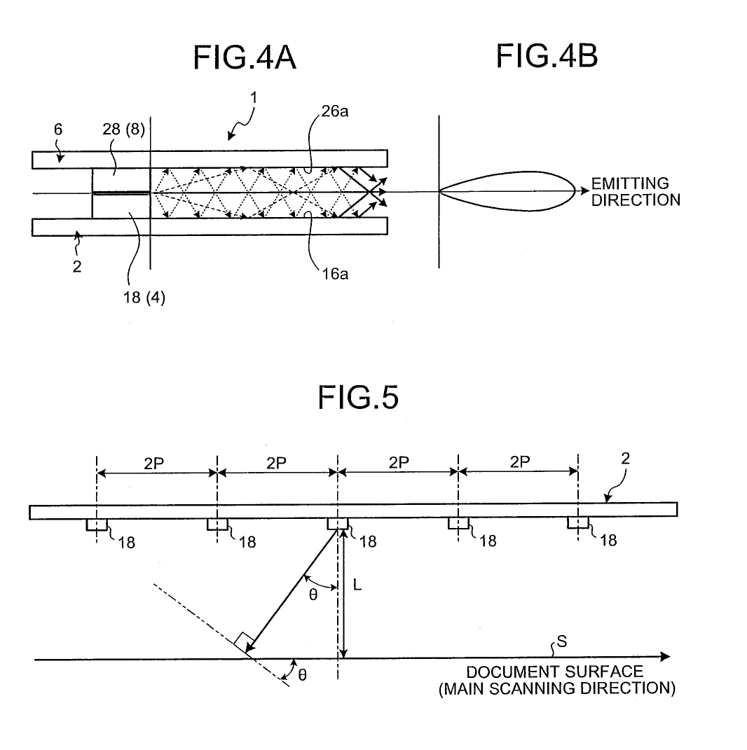

In the lighting apparatus 1, when the LEDs linearly arranged, that is, the LEDs arranged along the main scanning direction in the first embodiment, in other words, each of the first LEDs 18 of the first LED group 4 arranged in line and each of the second LEDs 28 of the second LED group 8 arranged in line, are simultaneously lit up by the lighting controlling unit not shown, the first light beams emitted from the respective first LEDs 18 of the first LED group 4 and the second light beams emitted from the respective second LEDs 28 of the second LED group 8 are applied toward the image reading medium S. Here as depicted in FIG. 4A, of the first light beams emitted from the first LEDs 18 of the first LED group 4 and the second light beams emitted from the second LEDs 28 of the second LED group 8, light beams toward the first substrate 2 or the second substrate 6 are repeatedly reflected from the reflection surfaces 16a and 26a provided to the first protruding portion 16 of the first substrate 2 and the second protruding portion 26 of the second substrate 6 facing each other, as the light beams go toward and closer to the image reading medium S. The light beams directed toward the first substrate 2 and the second substrate 6 are diffused if the first protruding portion 16 and the second protruding portion 26 are not provided in the first substrate 2 and the second substrate 6. Because of the reflection surface 16a of the first protruding portion 16 and the reflection surface 26a of the second protruding portion 26, the light beams toward the first substrate 2 or the second substrate 6 are applied to the image reading medium S in a state of being converged in a space between the first and second protruding portions 16 and 26. As a result, the first light beams emitted from the respective first LEDs 18 of the first LED group 4 and the second light beams emitted from the respective second LEDs 8 of the second LED group 8 are simultaneously applied to the image reading medium S. The image reading medium S is linearly lit up along the main scanning direction. Also, as explained above, the first light beams emitted from the respective first LEDs 18 of the first LED group 4 and the second light beams emitted from the respective second LEDs 8 of the second LED group 8 are applied to the image reading medium S in a state of being converged by the reflection surface 16a of the first protruding portion 16 and the reflection surface 26a of the second protruding portion 26 in a space between the first and second protruding portions 16 and 26. Therefore, as can be seen from a luminance distribution of the first light beams emitted from the first LEDs 18 and the second light beams emitted from the second LEDs 28 depicted in FIG. 4B, illuminance of the first light beams and the second light beams applied to the image reading medium S is increased. Here, for example, of linear light beams to light up the lighting target, those at positions with a relatively low illuminance have their illuminance increased. This can prevent ripples from occurring in linear light beams that light up the lighting target.

Also, in the arranging direction of the first and second LEDs 18 and 28, the light beams toward the first or second substrate 2 or 6, in other words, the light beams that would not be converged to a space between the first and second protruding portions 16 and 26 if the first and second protruding portions 16 and 26 and the reflection surfaces 16a and 26a were not provided are reflected from the reflection surface 16a and the reflection surface 26b to be sufficiently diffused. Therefore, even when the distance between the lighting apparatus 1 and the image reading medium S is relatively shortened, it is possible to suppress the occurrence of ripples in the linear light that lights up the image reading medium S along the main scanning direction.

Furthermore, in the lighting apparatus 1, for example, compared with the case where a plurality of LEDs are arranged in line and spaced apart with a space (2×P) on one substrate along the main scanning direction, the LEDs can be densely arranged along the main scanning direction. Therefore, with the occurrence of ripples in the first and second light beams applied from the first and second LEDs 18 and 28 to the image reading medium S as the lighting target being suppressed, the distance from the light-emitting surfaces of the first and second LEDs 18 and 28 to the image reading medium S as the lighting target can be shortened. At this time, as explained above, the illuminance of the first and second beams emitted from the first and second LEDs 18 and 28 is increased. Therefore, even if the current required for one first LED 18 or second LED 28 to emit light is decreased, the amount of light emission of the LEDs required for lighting up the image reading medium S can be maintained. Thus, the heat generation at each of the first and second LEDs 18 and 28 can be suppressed. For example, it is possible to suppress the influence of heat occurring at the first and second LEDs 18 and 28 onto the first and second substrates 2 and 6.

Meanwhile, in the lighting apparatus 1, when the pair of substrates, in other words, the first and second substrates 2 and 6, are printed boards, for example, the printed boards are manufactured so that the color of a resist on the mounting surface of each substrate, that is, the color of a resist on the first mounting surface 14a of the first substrate 2 and the second mounting surface 24a of the second substrate 6 is white. With this, it is possible to fabricate the reflection surfaces 16a and 26a at the same time when the printed boards are manufactured. Also, since the reflection surfaces 16a and 26a are each fabricated from a resist used in manufacturing the printed board, an increase in cost required for fabricating the reflection surfaces 16a and 26a can be suppressed.

In the image reading apparatus 32 including the lighting apparatus 1 as explained above, it is possible to suppress the occurrence of ripples in the linear light that lights up the image reading medium S. Therefore, for example, the image of the image reading medium S imaged by the imaging unit 33 can be made clear with variations in illuminance being suppressed. Furthermore, even if the distance between the lighting apparatus 1 and the image reading medium S is relatively shortened, it is possible to suppress the occurrence of ripples in the linear light that lights up the image reading medium S. Thus, with the lighting apparatus 1 being disposed relatively near the image reading medium S, the image reading apparatus 32 can be downsized, for example.

Here, although it is assumed in the first embodiment that the first substrate 2 is in a rectangular plate shape, the present invention is not meant to be limited to this. Alternatively, if an LED non-mounting area where no first LED 18 is mounted is present on the first mounting surface 14a in the direction of arranging the first LEDs 18 when viewed from a plate-thickness direction of the first substrate 2, a portion of the first protruding portion 16 on a first-light-emitting direction side from the LED non-mounting area may be notched, for example. Similarly, if an LED non-mounting area where no second LED 28 is mounted is present on the second mounting surface 24a in the direction of arranging the second LEDs 28 when viewed from a plate-thickness direction of the second substrate 6, a portion of the second protruding portion 26 on a second-light-emitting direction side from the LED non-mounting area may be notched, for example.

### Second Embodiment

A lighting apparatus according to a second embodiment is explained below. FIG. 5 is a schematic diagram for explaining the illuminance of light emitted from the lighting apparatus according to the second embodiment. Note that components similar to those in the first embodiment explained above are provided with the same reference numerals and not explained herein.

As depicted in FIG. 5, in the lighting apparatus 1 according to the second embodiment, when a distance between the light-emitting surfaces of the first and second LEDs 18 and 28 and the image reading medium S is L, and an LED arrangement pitch between the first and second LEDs 18 and 28 along the main scanning direction in the second embodiment is P, the distance L and the LED arrangement pitch P satisfy the following equation (1):

L/P≧1.5 (1)

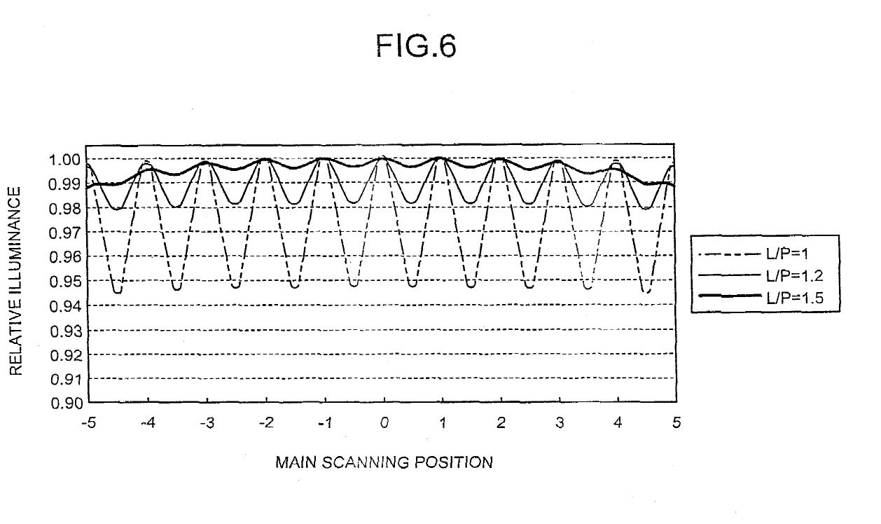

FIG. 6 is a graph of measurement results of ripples in the linear light applied from the lighting apparatus 1 to the image reading medium S. Here, the case of L/P=1, the case of L/P=1.2, and the case of L/P=1.5 are exemplarily depicted. From a graph of FIG. 6, it can be found that as the value of L/P is increased from 1 through 1.2 to 1.5, the ripples representing variations in relative illuminance are suppressed more.

In FIG. 5, a reference character “θ” represents an incident angle at which light emitted from an LED is incident on the image reading medium S on a plane that perpendicularly crosses the image reading medium S along the main scanning direction.

In the lighting apparatus 1 according to the second embodiment, the distance between the light-emitting surfaces of the first and second LEDs 18 and 28 and the image reading medium S is 1.5 times longer than the LED arrangement pitch P between the first LEDs 18 and the second LEDs 28 along the main scanning direction in the second embodiment. Therefore, as also depicted in the graph of FIG. 6, it is possible to further suppress the occurrence of ripples in the linear light that lights up the image reading medium S along the main scanning direction.

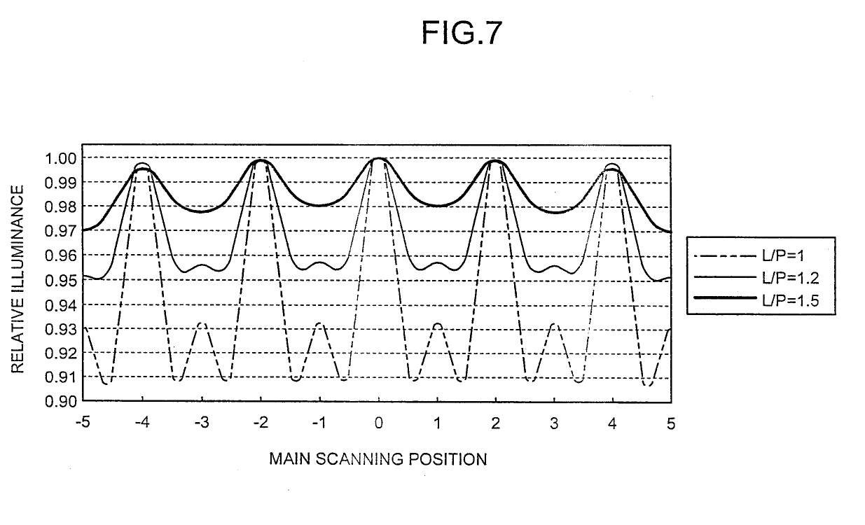

FIG. 7 is a graph of measurement results of ripples in the linear light applied from the lighting apparatus 1 to the image reading medium S when variations in luminance occur among the LEDs. Here, the case of L/P=1, the case of L/P=1.2, and the case of L/P=1.5 are exemplarily depicted. Also, the variations in luminance among the LEDs are ±10%. From a graph of FIG. 7, it can be found that, when luminance varies among the LEDs, ripples occur in the linear light that lights up the image reading medium S along the main scanning direction but, as with the case depicted in FIG. 6, as the value of L/P is increased from 1 through 1.2 to 1.5, the ripples representing variations in relative illuminance are suppressed more.

### Third Embodiment

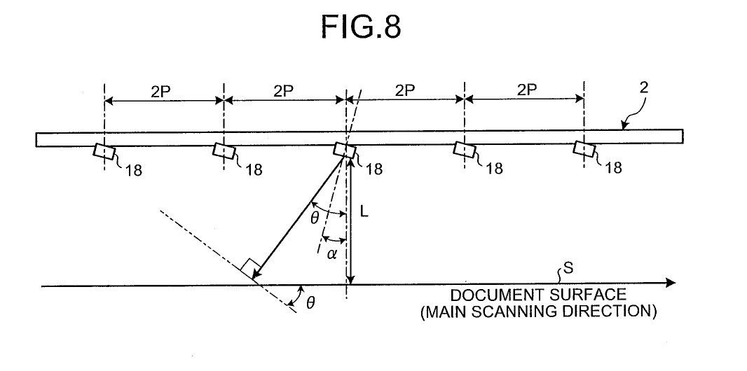

A lighting apparatus according to a third embodiment is explained below. FIG. 8 is a schematic drawing of the lighting apparatus according to the third embodiment. Note that components similar to those in the first and second embodiments explained above are provided with the same reference numerals and not explained herein.

In the lighting apparatus 1 according to the third embodiment, when a distance between the light-emitting surfaces of the first and second LEDs 18 and 28 and the image reading medium S is L, an LED arrangement pitch between the first and second LEDs 18 and 28 along the main scanning direction in the third embodiment is P, and an angle formed by a normal of an illumination surface of the image reading medium S to which the first and second light beams from the first and second LEDs 18 and 28 are applied and an optical axis of the first and second light beams emitted from the first and second LEDs 18 and 28 is α, the distance L, the LED arrangement pitch P, and the angle α satisfy the following equation (2):

L/P≧1.5/cos α (2)

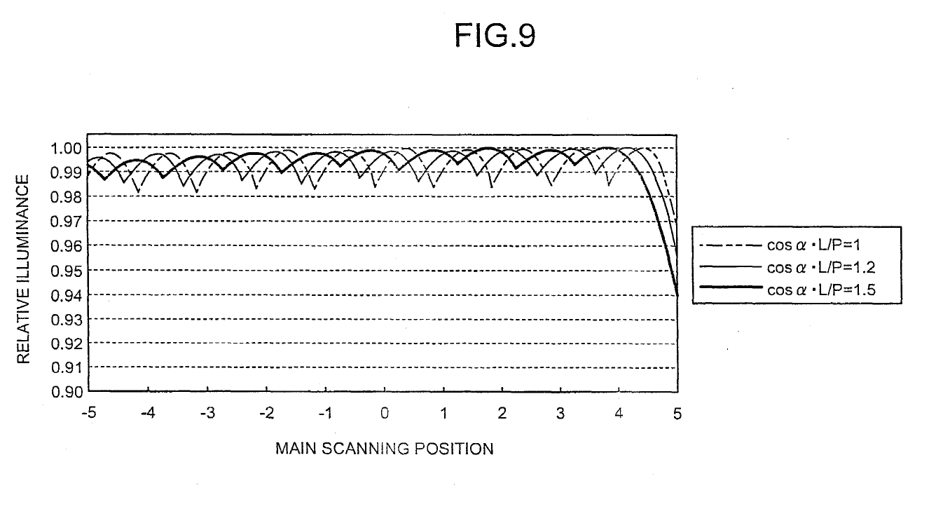

FIG. 9 is a graph of the measurement results of ripples in the linear light applied from the lighting apparatus 1 to the image reading medium S. Here, the case of cos α·L/P=1, the case of cos α·L/P=1.2, and the case of cos α·L/P=1.5 are exemplarily depicted. From a graph of FIG. 9, it can be found that as cos α·L/P is increased from 1 through 1.2 to 1.5, the ripples representing variations in relative illuminance are suppressed more.

In the lighting apparatus 1 according to the third embodiment, the result obtained by multiplying the distance L between the light-emitting surfaces of the first and second LEDs 18 and 28 and the image reading medium S by the cosine of the angle α formed by the normal of the illumination surface of the image reading medium S and the optical axis of the first and second light beams is 1.5 times or more longer than the LED arrangement pitch P between the first LEDs 18 and the second LEDs 28 along the main scanning direction in the third embodiment. Therefore, as also depicted in the graph of FIG. 9, it is possible to further suppress the occurrence of ripples in the linear light that lights up the image reading medium S along the main scanning direction.

Furthermore, in the lighting apparatus 1 according to the third embodiment, compared with the lighting apparatus 1 according to the second embodiment, the first and second light beams emitted from the first and second LEDs 18 and 28 are applied to the image reading medium S as overlapping each other more. Therefore, even if an LED becomes defective in lighting, it is possible to suppress a decrease in relative illuminance at a position corresponding to the lighting-defective LED in the main scanning direction.

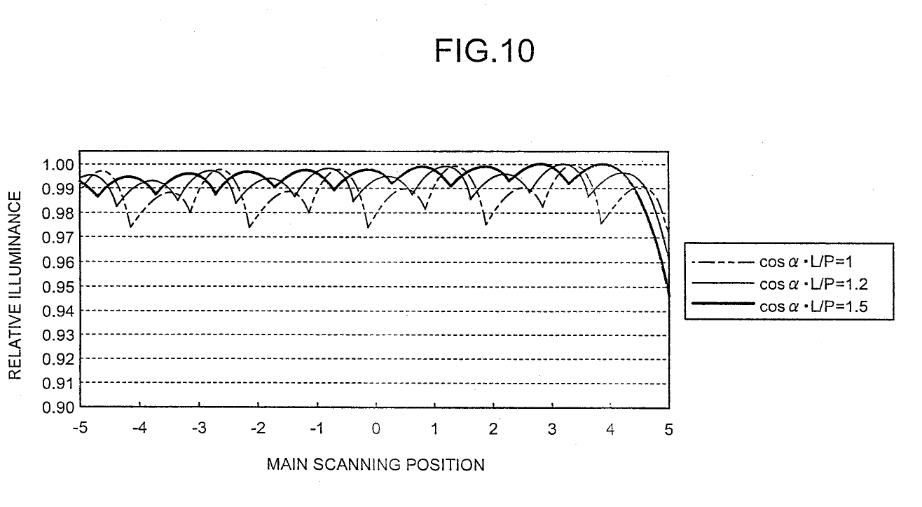

FIG. 10 is a graph of measurement results of ripples in the linear light applied from the lighting apparatus 1 to the image reading medium S when variations in luminance occur among the LEDs. Here, the case of cos α·L/P=1, the case of cos α·L/P=1.2, and the case of cos α·L/P=1.5 are exemplarily depicted. Also, the angle α formed by the normal of the illumination surface of the image reading medium S and the optical axis of the light beams emitted from the LEDs is 60 degrees. Furthermore, variations in luminance among the LEDs are ±10%. From a graph of FIG. 10, it can be found that, although ripples occur in the linear light that lights up the image reading medium S along the main scanning direction when luminance varies among the LEDs, as with the case depicted in FIG. 9, as cos α·L/P is increased from 1 through 1.2 to 1.5, the ripples representing variations in relative illuminance are suppressed more.

### Fourth Embodiment

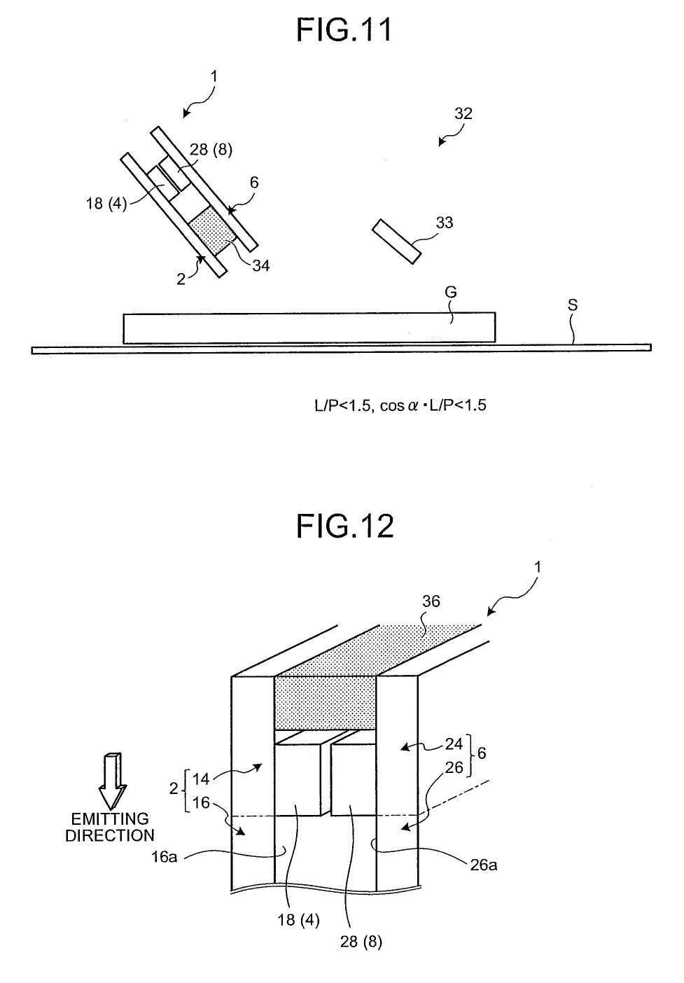

A lighting apparatus according to a fourth embodiment is explained below. FIG. 11 is a schematic side view of the lighting apparatus according to the fourth embodiment. Note that components similar to those in the first to third embodiments explained above are provided with the same reference numerals and not explained herein.

The lighting apparatus 1 according to the fourth embodiment includes a diffusion transmission member 34. The diffusion transmission member 34 diffuses the first and second light beams emitted from the first LEDs 18 and the second LEDs 28 for application to the image reading medium S. The diffusion transmission member 34 is provided in the lighting apparatus 1 at the first protruding portion 16 of the first substrate 2 and the second protruding portion 26 of the second substrate 6 between the first and second mounting surfaces 14a and 24a. The diffusion transmission member 34 is interposed, for example, between the first protruding portion 16 of the first substrate 2 and the second protruding portions 26 of the second substrate 6 and held by the first and second protruding portions 16 and 26 In the fourth embodiment, with the diffusion transmission member 34, an exposed portion of the reflection surface 16a of the first protruding portion 16 and an exposed portion of the reflection surface 26a of the second protruding portion 26 are each divided into two in the direction of emitting the first and second light beams. That is, the diffusion transmission member 34 is provided at an intermediate portion of the reflection surface 16a of the first protruding portion 16 and the reflection surface 26a of the second protruding portion 26 in the direction of emitting the first and second light beams. The diffusion transmission member 34 is made of a transparent member with a light transmission property. The diffusion transmission member 34 has, for example, a transparent resin surface formed with fine asperities, with which the first and second light beams passing through the diffusion transmission member 34 are diffused.

In the lighting apparatus 1 according to the fourth embodiment, when a distance between the light-emitting surfaces of the first and second LEDs 18 and 28 and the image reading medium S is L and an LED arrangement pitch between the first and second LEDs 18 and 28 along the main scanning direction in the fourth embodiment is P, the distance L and the LED arrangement pitch P satisfy the following equation (3):

L/P<1.5 (3)

In the lighting apparatus 1 according to the fourth embodiment, the first and second light beams emitted from the first and second LEDs 18 and 28 are diffused by the diffusion transmission member 34 provided on the first protruding portion 16 of the first substrate 2 and the second protruding portion 26 of the second substrate 6 between the first and second mounting surfaces 14a and 24a, that is, on a light-target side of the first and second substrates 2 and 6, and are then applied to the image reading medium S. Therefore, the first and second light beams emitted from the respective LEDs, in other words, the first and second LEDs 18 and 28, are further diffused along the emitting direction, that is, the arranging direction of the respective LEDs, that is, the first and second LEDs 18 and 28, when viewed along the main scanning direction in the fourth embodiment. Thus, it is possible to further suppress the occurrence of ripples in the linear light that lights up the image reading medium S.

Here, in the lighting apparatus 1 according to the fourth embodiment, when a distance between the light-emitting surfaces of the first and second LEDs 18 and 28 and the image reading medium S is L, an LED arrangement pitch between the first and second LEDs 18 and 28 along the main scanning direction in the fourth embodiment is P, and an angle formed by a normal of an illumination surface of the image reading medium S to which the first and second light beams from the first and second LEDs 18 and 28 and an optical axis of the first and second light beams emitted from the first and second LEDs 18 and 28 is α, the distance L, the LED arrangement pitch P, and the angle α satisfy the following equation (4):

L/P<1.5/cos α (4)

Also with the lighting apparatus 1 satisfying the equation (4), for the reasons similar to those explained above in the fourth embodiment, it is possible to further suppress the occurrence of ripples in the linear light that lights up the image reading medium S along the main scanning direction.

### Fifth Embodiment

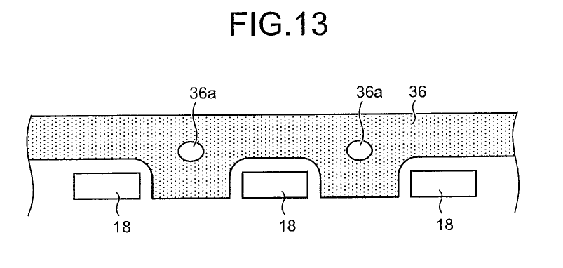

A lighting apparatus according to a fifth embodiment is explained below. FIG. 12 is a perspective view of a characteristic portion of the lighting apparatus according to the fifth embodiment. FIG. 13 is a cross-sectional view of the characteristic portion of the lighting apparatus of FIG. 12. Note that components similar to those in the first to fourth embodiments explained above are provided with the same reference numerals and not explained herein.

The lighting apparatus 1 according to the fifth embodiment includes a high-thermal-conductivity member 36. With the first and second LEDs 18 and 28 emitting the first and second light beams, the high-thermal-conductivity member 36 absorbs heat occurring at the first and second substrates 2 and 6. The high-thermal-conductivity member 36 holds the first and second substrates 2 and 6 at a position other than the reflection surface 16a of the first substrate 2 and the reflection surface 26a of the second substrate 6, that is, the first mounting surface 14a of the first substrate 2 and the second mounting surface 24a of the second substrate 6. In the fifth embodiment, the high-thermal-conductivity member 36 is provided at an end of the first and second substrates 2 and 6 opposite to the other end thereof on the image-reading-medium S side with respect to the first and second LEDs 18 and 28 in the emitting direction. More specifically, the high-thermal-conductivity member 36 is mounted at the end of the first and second substrates 2 and 6 opposite to the other end thereof on the image-reading-medium S side with respect to the first and second LEDs 18 and 28 so as to be in intimate contact with both of the first and second substrates 2 and 6. Thus, the first and second LEDs 18 and 28 are held by the high-thermal-conductivity member 36 via the first and second substrates 2 and 6. The high-thermal-conductivity member 36 has a thermal capacity larger than that of the first and second substrates 2 and 6. Note that, in FIG. 13, reference characters “36a” each denote a space for suppressing thermal expansion of the high-thermal-conductivity member 36.

In the lighting apparatus 1 according to the fifth embodiment, the first and second substrates 2 and 6 are held by the high-thermal-conductivity member 36 at a position other than the reflection surface 16a of the first substrate 2 and the reflection surface 26a of the second substrate 6, in other words, the first mounting surface 14a of the first substrate 2 and the second mounting surface 24a of the second substrate 6. Thus, for example, with the capability of suppressing the occurrence of ripples in the linear light that lights up the image reading medium S being kept, it is possible to keep the first and second substrates 2 and 6 so that these substrates are parallel to each other to suppress warpage of each of these substrates, that is, the first and second substrates 2 and 6, and also to improve the degree of thermal diffusion and heat dissipation of the first and second substrates 2 and 6. Therefore, for example, when the high-thermal-conductivity member 36 has a thermal capacity enough to diffuse and absorb heat occurring at the first and second substrates 2 and 6, the heat occurring at the first and second substrates 2 and 6 can be absorbed only by the high-thermal-conductivity member 36. Therefore, a heat dissipating process for the first and second substrates 2 and 6 can be dispensed with.

### Sixth Embodiment

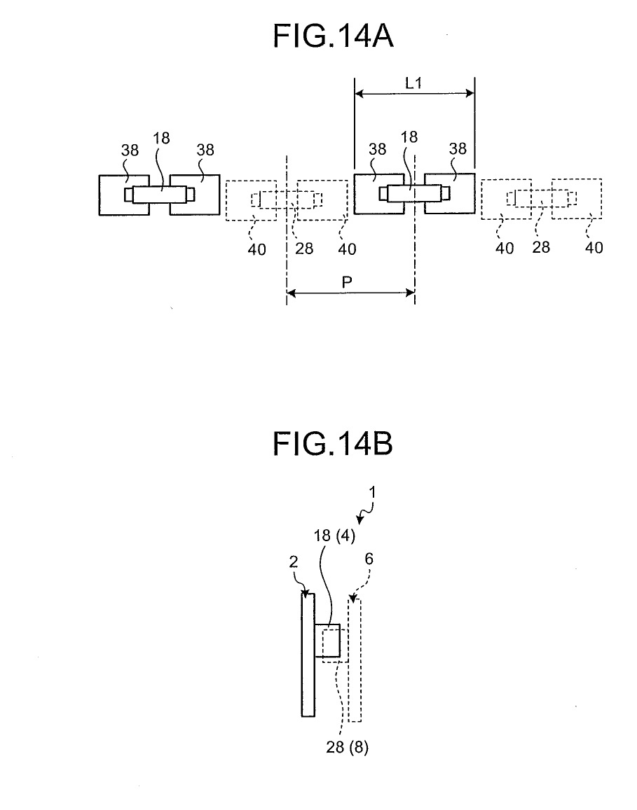

A lighting apparatus according to a sixth embodiment is explained below. FIG. 14A is a front view of a characteristic portion of the lighting apparatus according to the sixth embodiment. FIG. 14B is a side view of the characteristic portion of the lighting apparatus according to the sixth embodiment. Note that components similar to those in the first to fifth embodiments explained above are provided with the same reference numerals and not explained herein.

In the lighting apparatus 1, the first mounting surface 14a of the substrate body 14 of the first substrate 2 has first mounting areas corresponding to the first LEDs 18 as many as the number of first LEDs 18. The first mounting areas are configured of the first LEDs 18 and first soldering pads 38 for mounting the first LEDs 18 on the first substrate 2. Each first mounting area is an area required for mounting one first LED 18 on the first substrate 2. The length of one first mounting area in the arranging direction of the first LEDs 18 is equivalent to the length of an area occupied by one first LED 18 and two first soldering pads 38 for mounting the one first LED 18 on the first mounting surface 14a of the first substrate 2. Also, the second mounting surface 24a of the substrate body 24 of the second substrate 6 has second mounting areas corresponding to the second LEDs 28 as many as the number of second LEDs 28. The second mounting areas are configured of the second LEDs 28 and second soldering pads 40 for mounting the second LEDs 28 on the second substrate 6. Each second mounting area is an area required for mounting one second LED 28 on the second substrate 6. The length of one second mounting area in the arranging direction of the second LEDs 28 is equivalent to the length of an area occupied by one second LED 28 and two second soldering pads 40 for mounting the one second LED 28 on the second mounting surface 24a of the second substrate 6. In the lighting apparatus 1, in the arranging direction of the first LEDs 18, in the main scanning direction in the sixth embodiment, the length of the first mounting area for one first LED 18 including the first soldering pads 38 for mounting the first LED 18 on the first substrate 2 is taken as L1. Furthermore, as with the case of the first LED 18, in the lighting apparatus 1, in the arranging direction of the second LEDs 28, in the main scanning direction in the sixth embodiment, the length of the second mounting area for one second LED 28 including the second soldering pads 40 for mounting the second LED 28 on the second substrate 6 is taken as L1. As depicted in FIG. 14A, when the first LEDs 18 and the first soldering pads 38 corresponding to these first LEDs 18 and the second LEDs 28 and the second soldering pads 40 corresponding to these second LEDs 28 are viewed from a direction in which the first and second substrates 2 and 6 face each other, the first LEDs 18 and the first soldering pads 38 corresponding to these first LEDs 18 and the second LEDs 28 and the second soldering pads 40 corresponding to these second LEDs 28 are alternately arranged so as not to overlap each other along a direction in which the first and second LEDs 18 and 28 are aligned, that is, the main scanning direction. Also, as depicted in FIG. 14B, when the lighting apparatus 1 is viewed along the main scanning direction, the first LEDs 18 and the second LEDs 28 overlap each other. That is, along the main scanning direction, one second LED 28 is positioned between two adjacent first LEDs 18 and one first LED 18 is positioned between two adjacent second LEDs 28. As a result, along the main scanning direction, the first LEDs 18 and the second LEDs 28 are alternately arranged one by one. Here, when an LED arrangement pitch between the first and second LEDs 18 and 28 is P, the length L1 and the LED arrangement pitch P satisfy the following equation (5):

L1>P (5).

In the lighting apparatus 1 according to the sixth embodiment, the LED arrangement pitch P between the first and second LEDs 18 and 28 is shorter than the length L1 representing the length of the first mounting area for one first LED 18 including the first soldering pads 38 and the length of the second mounting area for one second LED 28 including the second soldering pads 40. Therefore, the first and second LEDs 18 and 28 can be densely arranged along the main scanning direction in the sixth embodiment. Thus, with the occurrence of ripples in the first and second light beams applied from the first and second LEDs 18 and 28 to the image reading medium S as the lighting target being suppressed, the distance L from the light-emitting surfaces of the first and second LEDs 18 and 28 to the image reading medium S as the lighting target can be shortened. At this time, as explained above, the illuminance of the first and second light beams emitted from the first and second LEDs 18 and 28 is increased. Therefore, even if the current required for one first LED 18 or second LED 28 to emit light is decreased, the amount of light emission of the LEDs required for lighting up the image reading medium S can be maintained. Thus, the heat generation at each of the first and second LEDs 18 and 28 can be suppressed. For example, it is possible to suppress the influence of heat occurring at the first and second LEDs 18 and 28 onto the first and second substrates 2 and 6.

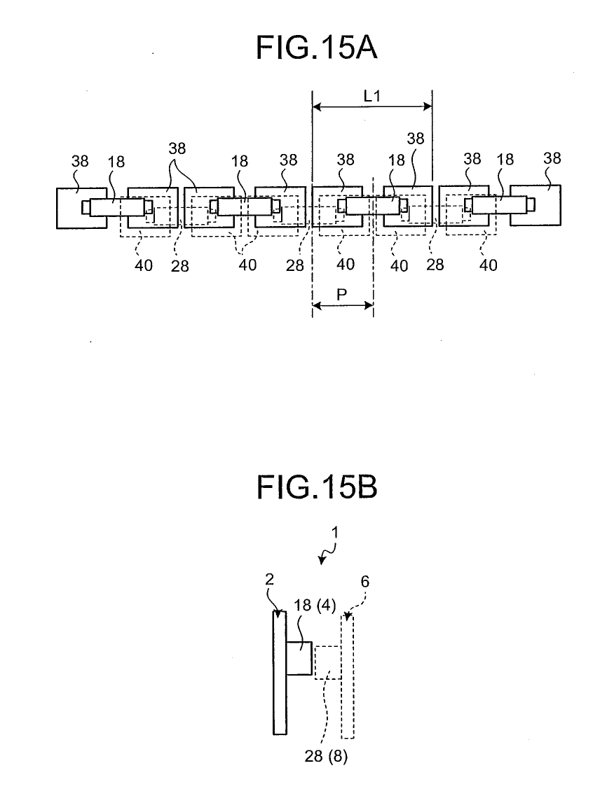

Here, in the sixth embodiment, as depicted in FIGS. 14A and 14B, when the first LEDs 18 and the first soldering pads 38 corresponding to these first LEDs 18 and the second LEDs 28 and the second soldering pads 40 corresponding to these second LEDs 28 are viewed from the direction in which the first and second substrates 2 and 6 face each other, the first LEDs 18 and the first soldering pads 38 corresponding to these first LEDs 18 and the second LEDs 28 and the second soldering pads 40 corresponding to these second LEDs 28 are alternately arranged so as not to overlap each other along the main scanning direction. Also, when the lighting apparatus 1 is viewed along the main scanning direction, the first LEDs 18 and the second LEDs 28 are arranged so as to overlap each other. The present invention is not meant to be restricted to this, however. Alternatively, in the present invention, the first LEDs 18 and the first soldering pads 38 corresponding to these first LEDs 18 and the second LEDs 28 and the second soldering pads 40 corresponding to these second LEDs 28 may be arranged as depicted in FIGS. 15A and 15B, for example. In more detail, as depicted in FIG. 15A, when viewed from the direction in which the first and second substrates 2 and 6 face each other, the first LEDs 18 and the first soldering pads 38 corresponding to these first LEDs 18 and the second LEDs 28 and the second soldering pads 40 corresponding to these second LEDs 28 are alternately arranged one by one so that the first and second LEDs 18 and 28 do not overlap each other along a direction in which the first and second LEDs 18 ad 28 are aligned in line, that is, the main scanning direction. Also, as for adjacent first and second LEDs 18 and 28, the first and second soldering pads 38 and 40 overlap each other along the main scanning direction at approximately the same position in the main scanning direction. Furthermore, as depicted in FIG. 15B, when the lighting apparatus 1 is viewed along the main scanning direction, the first and second LEDs 18 and 28 are arranged so as not to overlap each other. Even when the first LEDs 18 and the first soldering pads 38 corresponding to these first LEDs 18 and the second LEDs 28 and the second soldering pads 40 corresponding to these second LEDs 28 are arranged in the manner as explained above, the first and second LEDs 18 and 28 do not interfere with each other. Even when the first LEDs 18 and the first soldering pads 38 corresponding to these first LEDs 18 and the second LEDs 28 and the second soldering pads 40 corresponding to these second LEDs 28 are arranged in a manner as depicted in FIGS. 15A and 15B, along the main scanning direction, one second LED 28 is positioned between two adjacent first LEDs 18 and one first LED 18 is positioned between two adjacent second LEDs 28. As a result, along the main scanning direction, the first LEDs 18 and the second LEDs 28 are alternately arranged one by one. Therefore, even when the first LEDs 18 and the first soldering pads 38 corresponding to these first LEDs 18 and the second LEDs 28 and the second soldering pads 40 corresponding to these second LEDs 28 are arranged in a manner as depicted in FIGS. 15A and 15B, for the reasons similar to those explained for the lighting apparatus 1 depicted in FIGS. 14A and 14B, the heat generation at each of the first and second LEDs 18 and 28 can be suppressed. For example, it is possible to suppress the influence of heat occurring at the first and second LEDs 18 and 28 onto the first and second substrates 2 and 6.

### Seventh Embodiment

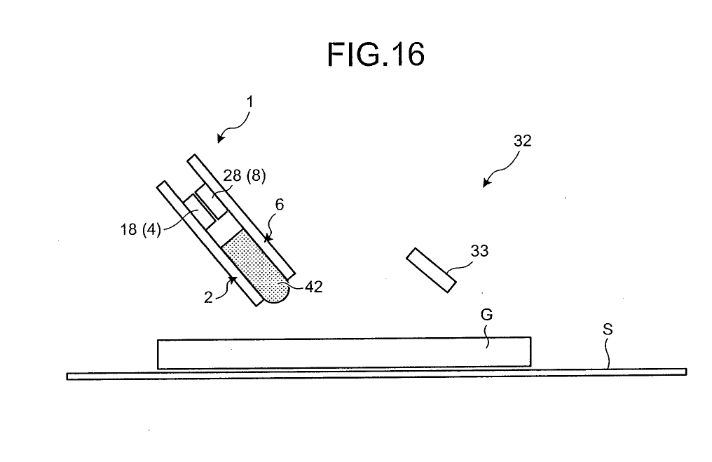

A lighting apparatus according to a seventh embodiment is explained below. FIG. 16 is a side drawing of the lighting apparatus according to the seventh embodiment when applied to an image reading apparatus. Note that components similar to those in the first to sixth embodiments explained above are provided with the same reference numerals and not explained herein.

The lighting apparatus 1 according to the seventh embodiment includes a cylindrical lens 42. The cylindrical lens 42 gathers the first and second light beams emitted from the first and second LEDs 18 and 28 for application to the image reading medium S. The cylindrical lens 42 is provided to the lighting apparatus 1 according to the seventh embodiment between the first and second mounting surfaces 14a and 24a at an end of the first and second substrates 2 and 6 forming a pair of substrates on an image-reading-medium S side so that a convex curved surface of the cylindrical lens faces the image reading medium S. This cylindrical lens 42 is interposed, for example, between the first and second protruding portions 16 and 26 and held by the first protruding portion 16 of the first substrate 2 and the second protruding portions 26 of the second substrate 6. That is, the cylindrical lens 42 blocks the end of the reflection surfaces 16a and 26a of the first and second protruding portions 16 and 26 on an image-reading-medium S side in the direction of emitting the first and second light beams. The cylindrical lens 42 is made of a transparent member with a light transmission property. The cylindrical lens 42 is formed of, for example, transparent resin, such as acryl or polycarbonate.

In lighting apparatus 1 according to the seventh embodiment, the first and second light beams emitted from the first and second LEDs 18 and 28 are gathered by the reflection surfaces 16a and 26a to a space between the first and second protruding portions 16 and 26, and are further gathered by the cylindrical lens 42 for application to the image reading medium S. Therefore, the illuminance of the first and second light beams applied to the image reading medium S is increased. It is thus possible to further suppress the occurrence of ripples in the linear light that lights up the image reading medium S along the main scanning direction in the seventh embodiment.

Here, in the first to seventh embodiments, it is assumed that the lighting apparatus 1 is used as a light source of an image reading apparatus. The present invention is not meant to be limited to this, however, and the lighting apparatus 1 can be used as, for example, a backlight of a liquid-crystal display apparatus. Even when the lighting apparatus 1 is used as a backlight of a liquid-crystal display apparatus, as with the first to seventh embodiments, it is possible to suppress the occurrence of ripples in the linear light that lights up the liquid-crystal panel as a lighting target.

In the present invention, when the linearly-arranged LEDs, in other words, each of the first LEDs of the first LED group arranged in line and the second LEDs of the second LED group arranged in line, are simultaneously lit up, the light beams emitted from the first and second LEDs are applied to the lighting target, and this lighting target is linearly lit up. Here, of the light beams emitted from the first LEDs of the first LED group and the second LEDs of the second LED group, those that are directed toward the first or second substrate are repeatedly reflected by the reflection surfaces provided to the first and second protruding portions of the first and second substrates facing each other while going toward the lighting target. That is, the light beams toward the first or second substrate, which would be diffused if the first and second protruding portions were not provided to the first and second substrates, are applied to the lighting target as being converged by the reflection surfaces of the first and second protruding portions to a space between the first and second protruding portions. Thus, of linear light beams to light up the lighting target, those at positions with a relatively low illuminance have their illuminance increased. With this, an effect can be achieved such that the occurrence of ripples in the linear light that lights up the lighting target can be suppressed.

Also, in the present invention, the light beams emitted from the first and second LEDs are diffused by the diffusion transmission member provided at the first protruding portion of the first substrate and the second protruding portion of the second substrate between the first and second mounting surfaces, that is, on a lighting-target side of the first and second substrates, and are then applied to the lighting target. Therefore, when viewed along the emitting direction, the light beams emitted from the respective LEDs are further diffused along the LED arranging direction. With this, an effect can be achieved such that the occurrence of ripples in the linear light that lights up the lighting target can be further suppressed.

Furthermore, in the present invention, when the first and second substrates are printed boards, for example, these printed boards are manufactured so that the color of a resist on the mounting surface of each substrate is white, thereby fabricating reflection surfaces at the same time when the printed boards are manufactured. Also, since the reflection surfaces are each fabricated from a resist for use in manufacturing the printed board, an effect can be achieved such that an increase in cost required for fabricating reflection surfaces can be suppressed.

Still further, in the present invention, the first and second substrates are held by the high-thermal-conductivity member at a position except for the reflection surfaces. Therefore, an effect can be achieved such that, with the capability of suppressing the occurrence of ripples in the linear light that lights up the lighting target being kept, it is possible to keep the first and second substrates so that these substrates are parallel to each other to suppress warpage of each substrate, and also to improve the degree of thermal diffusion and heat dissipation of each substrate.

Still further, in the present invention, the light beams emitted from the first and second LEDs are converged by the reflection surfaces to a space between the first and second protruding portions, and are further gathered by the cylindrical lens for application to the lighting target. Thus, the illuminance of the light applied to the lighting target is increased. Therefore, an effect can be achieved such that it is possible to further suppress the occurrence of ripples in the linear light applied to the lighting target.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A lighting apparatus that lights up a lighting target comprising:
a first substrate having a first mounting surface;
a first LED group formed of a plurality of first LEDs of side-view type each mounted on the first mounting surface to emit a first light beam from a side surface facing the lighting target toward the lighting target, the first LEDs being arranged so as to be equally spaced in line in an arranging direction;
a second substrate having a second mounting surface facing the first mounting surface; and
a second LED group formed of a plurality of second LEDs of side-view type each mounted on the second mounting surface to emit a second light beam from a side surface facing the lighting target toward the lighting target, the second LEDs being arranged so as to be equally spaced in line in the arranging direction, and the second LED group being arranged at a position facing the first LED group,
a first arrangement pitch representing a pitch between the first LEDs of the first LED group being shifted in phase in the arranging direction from a second arrangement pitch representing a pitch between the second LEDs of the second LED group,
the first substrate having a first protruding portion that protrudes from a lighting-target side of the mounted first LED group toward the lighting target,
the second substrate having a second protruding portion that protrudes from a lighting-target side of the mounted second LED group toward the lighting target, and
a reflection surface that reflects the first light beams and the second light beams being formed at a first-mounting-surface side of the first protruding portion, and at a second-mounting-surface side of the second protruding portion.

2. The lighting apparatus according to claim 1, wherein
a phase shift between the first arrangement pitch and the second arrangement pitch is ½.

3. The lighting apparatus according to claim 2, wherein
when a distance between the lighting target and each of the first LEDs and the second LEDs is L and an LED arrangement pitch between the first and second LEDs is P, the distance L and the LED arrangement pitch P satisfy an equation (1):
L/P≧1.5 (1).

4. The lighting apparatus according to claim 2, wherein
when a distance between the lighting target and each of the first LEDs and the second LEDs is L, an LED arrangement pitch between the first and second LEDs is P, and an angle formed by a normal of an illumination surface of the lighting target to which the light beams from the first LEDs and the second LEDs are applied and an optical axis of the light beams emitted from the first LEDs and the second LEDs is α, the distance L, the LED arrangement pitch P, and the angle α satisfy an equation (2):
L/P≧1.5/cos α (2).

5. The lighting apparatus according to claim 1, wherein
a diffusion transmission member that diffuses the light beams emitted from the first LEDs and the second LEDs for application to the lighting target is provided at the first protruding portion and the second protruding portion between the first mounting surface and the second mounting surface.

6. The lighting apparatus according to claim 1, wherein
the reflection surface of the first substrate is integrally formed with the first mounting surface,
the reflection surface of the second substrate is integrally formed with the second mounting surface, and
the first mounting surface, the second mounting surface, and the reflection surfaces are white resists.

7. The lighting apparatus according to claim 1, wherein
the first substrate and the second substrate are held by a high-thermal-conductivity member at a position except for the reflection surfaces.

8. The lighting apparatus according to claim 1, wherein
the first mounting surface has a first mounting area corresponding to each of the first LEDs,
the second mounting surface has a second mounting area corresponding to each of the second LEDs,
the first mounting area is formed of the first LED and a first soldering pad for mounting the first LED onto the first substrate,
the second mounting area is formed of the second LED and a second soldering pad for mounting the second LED onto the second substrate,
in the arranging direction, when each of the first mounting area and the second mounting area has a length of L1 and an LED arrangement pitch between the first and second LEDs is P, the length L1 and the LED arrangement pitch P satisfy an equation (3):
L1>P (3).

9. The lighting apparatus according to claim 1, wherein
a cylindrical lens for gathering the light beams emitted from the first LEDs and the second LEDs for application to the lighting target is provided between the first mounting surface and the second mounting surface at a lighting-target-side end of the first protruding portion and the second protruding portion so that a convex curved surface of the cylindrical lens faces the lighting target.

10. An image reading apparatus comprising:
the lighting apparatus according to claim 1; and
an imaging unit that images an image reading medium, which is a lighting target lit up by the lighting apparatus.
